(19) United States
(12) Patent Application Publication
(10) Pub. No.: US 2013/0307361 A1
(43) Pub. Date: Nov. 21, 2013

(54) FAN MOTOR SILICON STEEL SHEET STRUCTURE AND FAN MOTOR THEREOF

(71) Applicants: Cheng-Wei Lai, New Taipei City (TW); Chia-Hsing Lin, New Taipei City (TW); Chun-Liang Ho, Sinjhuang City (TW)

(72) Inventors: Cheng-Wei Lai, New Taipei City (TW); Chia-Hsing Lin, New Taipei City (TW); Chun-Liang Ho, Sinjhuang City (TW)

(21) Appl. No.: 13/472,184

(22) Filed: May 15, 2012

(51) Int. Cl. H02K 5/16; B32B 3/24

(52) U.S. Cl. 310/90; 428/596

(57) ABSTRACT

A fan motor silicon steel sheet structure and a fan motor thereof. The silicon steel sheet structure includes a silicon steel sheet assembly having multiple silicon steel sheets, which overlap one another. The silicon steel sheets include at least one first silicon steel sheet and multiple second silicon steel sheets. The first silicon steel sheet has a first bore and at least one protrusion section. The protrusion section inward protrudes from an inner circumference of the first bore. The first silicon steel sheet is overlaid on one side of the second silicon steel sheets. Each of the second silicon steel sheets has a second bore in communication with the first bore. The fan motor silicon steel sheet structure is able to effectively secure the bearing and provide a dustproof effect. With such structure, the manufacturing cost of the fan motor is lowered.

### BACKGROUND OF THE INVENTION

1. Field of the Invention

The present invention relates to a silicon steel sheet structure and a fan motor thereof. The silicon steel sheet structure is able to effectively secure the bearing and provide a dustproof effect. With such structure, the manufacturing cost of the fan motor is lowered.

2. Description of the Related Art

Following the development of electronic industries, the function and operation speed of all kinds of electronic products have been rapidly promoted. When the electronic products operate at higher and higher speed, they generate higher and higher heat at the same time. The heat must be efficiently dissipated so as to keep the electronic products operating normally. Conventionally, a fan is often used to create airflow for forcedly dissipating the heat and keeping the electronic product at a normal operation temperature.

Please refer to FIGS. 1A and 1B. The conventional fan 1 includes a frame body 10, a rotor 11 and a stator 12. The frame body 10 has a receiving space 101. A base seat 13 is fixedly disposed at the center of the receiving space 101. A bearing cup 131 axially protrudes from the base seat 13. The rotor 11 is rotatably connected to the bearing cup 131. The bearing cup 131 has a bearing hole 1311. The wall of the bearing hole 1311 is formed with a recessed section 1313. A bearing 15 is received in the bearing hole 1311. A shaft 111 of the rotor 11 is fitted in the bearing 15.

The recessed section 1313 is formed on the wall of the bearing hole 1311 at an end of the bearing cup 131, which end is proximal to the rotor 11. A retainer ring 16 and a fixing member 17 are disposed in the recessed section 1313. The retainer ring 16 is fitted around the shaft 111 and inlaid in an annular groove 1111 formed on the shaft 111. The fixing member 17 is disposed on one face of the retainer ring 16 for pressing the retainer ring 16 against the bearing 15 so as to secure the bearing 15.

In the conventional fan 1, the fixing member 17 serves to press the retainer ring 16 against the bearing 15 so as to indirectly secure the bearing 15. This leads to a problem that in the manufacturing process of the conventional fan 1, it is necessary to additionally manufacture the fixing member 17 for securing the bearing 15. Moreover, it takes much time to accurately affix the fixing member 17 to the retainer ring 16. As a result, as a whole, the cost is increased and the working time is prolonged.

According to the above, the conventional fan has the following shortcomings:

1. The cost is increased.

2. The working time is prolonged.

3. The assembling process is complicated.

### SUMMARY OF THE INVENTION

A primary object of the present invention is to provide a fan motor silicon steel sheet structure, which is able to effectively secure the bearing and provide a dustproof effect.

A further object of the present invention is to provide the above fan motor silicon steel sheet structure. With the fan motor silicon steel sheet structure, the manufacturing cost of the fan motor is lowered and the working time is shortened.

A still further object of the present invention is to provide a fan motor including a silicon steel sheet structure, which is able to effectively secure the bearing and provide a dustproof effect.

A still further object of the present invention is to provide the above fan motor, which is manufactured at lower cost with working time shortened.

To achieve the above and other objects, the fan motor silicon steel sheet structure of the present invention includes a silicon steel sheet assembly. The silicon steel assembly has multiple silicon steel sheets, which overlap one another. The silicon steel sheets include at least one first silicon steel sheet and multiple second silicon steel sheets. The first silicon steel sheet has a first bore and at least one protrusion section. The first bore is formed at a center of the first silicon steel sheet. The protrusion section inward protrudes from an inner circumference of the first bore. The first silicon steel sheet is overlaid on one side of the second silicon steel sheets. Each of the second silicon steel sheets has a second bore formed at a center of the second silicon steel sheet in communication with the first bore. The fan motor silicon steel sheet structure is able to effectively secure the bearing and provide a dustproof effect. With such structure, the manufacturing cost of the fan motor is lowered.

The fan motor of the present invention includes a base seat, a rotor and a stator. The base seat has a bearing cup axially extending from the base seat. The bearing cup has a bearing hole for receiving a bearing therein. The rotor has a shaft fitted through the bearing, which is disposed in the bearing hole of the bearing cup, whereby the shaft is rotatably positioned in the bearing cup. The stator is fitted around the bearing cup. The stator includes a silicon steel sheet assembly and a winding assembly wound on the silicon steel sheet assembly. The silicon steel sheet assembly has multiple silicon steel sheets. The multiple silicon steel sheets include at least one first silicon steel sheet and multiple second silicon steel sheets. The first silicon steel sheet is overlaid on one side of the second silicon steel sheets. The first silicon steel sheet has a first bore in communication with the bearing hole and at least one protrusion section. The first bore is formed at a center of the first silicon steel sheet. The protrusion section inward protrudes from an inner circumference of the first bore. One face of the protrusion section abuts against the bearing cup and the bearing. Each of the second silicon steel sheets has a second bore formed at a center of the second silicon steel sheet in communication with the first bore. The protrusion section of the first silicon steel sheet serves to abut against the bearing cup and the bearing to apply a pressing force onto the bearing so as to effectively secure the bearing and provide a dustproof effect. With the silicon steel sheet structure, the manufacturing cost of the fan motor is lowered and the working time is shortened.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view of a conventional fan;

FIG. 1B is a sectional assembled view of the conventional fan;

FIG. 2 is a perspective exploded view of a first embodiment of the present invention;

FIG. 3 is a perspective assembled view of the first embodiment of the present invention;

FIG. 4 is a perspective assembled view of a second embodiment of the present invention;

FIG. 5 is a perspective exploded view of the second embodiment of the present invention;

FIG. 6 is a sectional assembled view of the second embodiment of the present invention;

FIG. 7 is a perspective exploded view of a third embodiment of the present invention; and

FIG. 8 is a sectional assembled view of the third embodiment of the present invention.

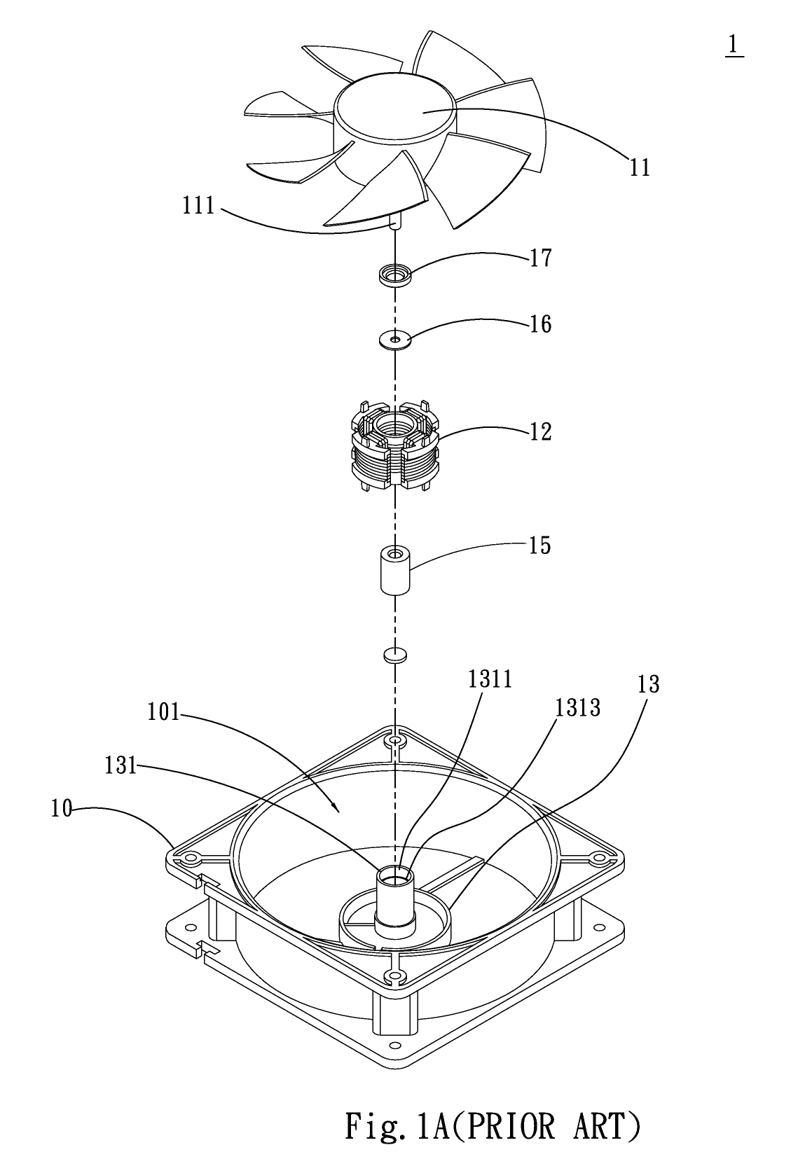

### DETAILED DESCRIPTION OF THE PREFERRED EMBODIMENTS

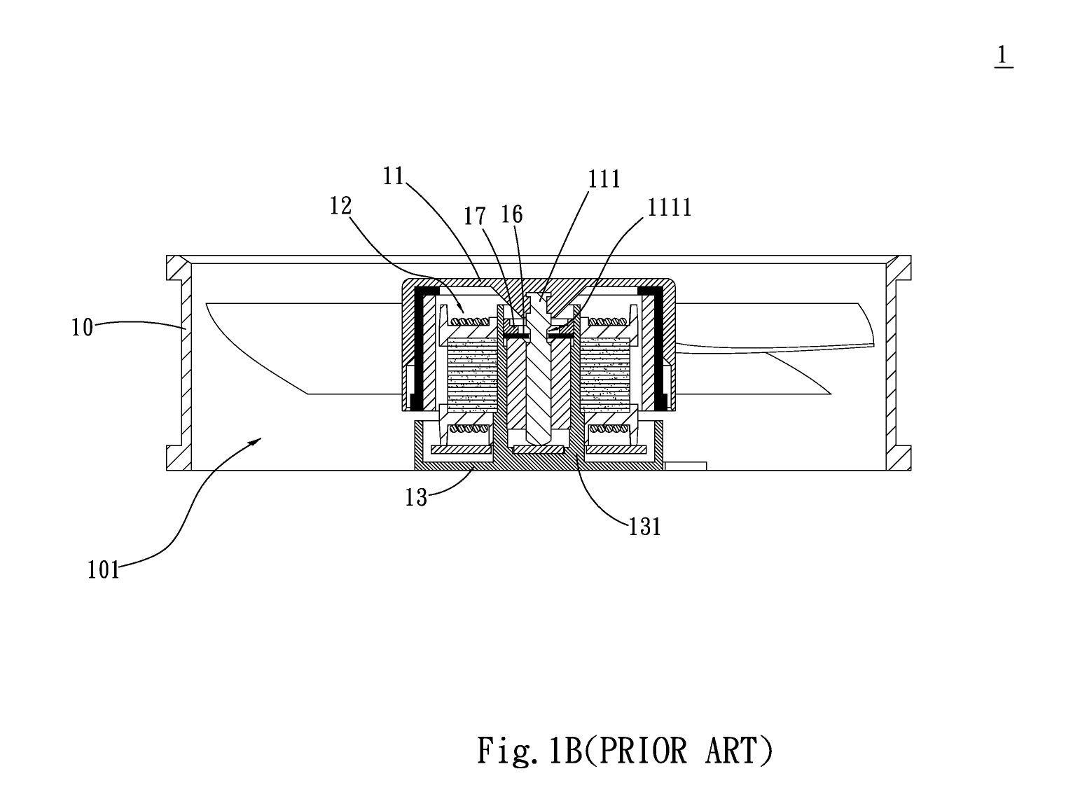

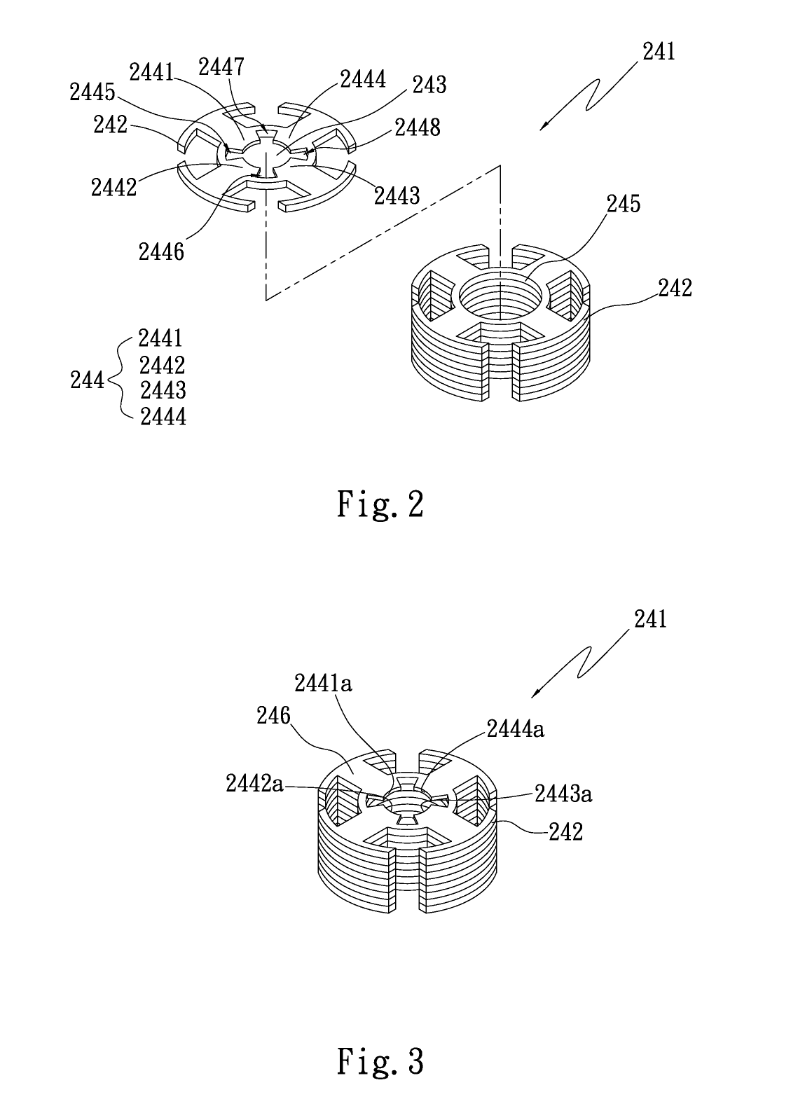

Please refer to FIGS. 2 and 3. FIG. 2 is a perspective exploded view of a first embodiment of the present invention. FIG. 3 is a perspective assembled view of the first embodiment of the present invention. According to the first embodiment, the silicon steel sheet structure of the present invention includes a silicon steel sheet assembly 241. The silicon steel assembly 241 has multiple silicon steel sheets 242, which overlap one another. Each silicon steel sheet 242 has multiple magnetic poles 246 outward extending from an outer circumference of the silicon steel sheet 242.

The silicon steel sheets 242 include at least one first silicon steel sheet 242 and multiple second silicon steel sheets 242. The first silicon steel sheet 242 is overlaid on one side of the second silicon steel sheets 242. In this embodiment, there is only one first silicon steel sheet 242, which is overlaid on one face of an uppermost second silicon steel sheet 242 for illustration purposes only. The first silicon steel sheet 242 has a first bore 243 and at least one protrusion section 244. The first bore 243 is formed at a center of the first silicon steel sheet 242. The protrusion section 244 inward protrudes from an inner circumference of the first bore 243. In this embodiment, there are four protrusion sections 244 for illustration purposes only. To speak more specifically, the first silicon steel sheet 242 has, but not limited to, a first protrusion section 2441, a second protrusion section 2442, a third protrusion section 2443 and a fourth protrusion section 2444. In practice, the number of the protrusion sections 244 can be changed according to the required pressing/fixing effect.

The first and third protrusion sections 2441, 2443 respectively protrude from two opposite sections of the inner circumference of the first bore 243 toward the center thereof. The second and fourth protrusion sections 2442, 2444 respectively protrude from two other opposite sections of the inner circumference of the first bore 243 toward the center thereof. The free ends of the first, second, third and fourth protrusion sections 2441, 2442, 2443, 2444, (which ends are distal from the inner circumference of the first bore 243), are formed with arched recesses 2441a, 2442a, 2443a, 2444a. The free ends of the first, second, third and fourth protrusion sections 2441, 2442, 2443, 2444 are radially recessed toward the inner circumference of the first bore 243 to form the arched recesses 2441a, 2442a, 2443a, 2444a respectively.

In this embodiment, the first, second, third and fourth protrusion sections 2441, 2442, 2443, 2444 are, but not limited to, arranged at equal intervals. Alternatively, the first, second, third and fourth protrusion sections 2441, 2442, 2443, 2444 can be arranged at unequal intervals.

Please further refer to FIGS. 2 and 3. Two sides of the second protrusion section 2442 and the adjacent first and third protrusion sections 2441, 2443 respectively define therebetween a first space 2445 and a second space 2446. The first and second spaces 2445, 2446 communicate with the first bore 243. Two sides of the fourth protrusion section 2444 and the adjacent first and third protrusion sections 2441, 2443 respectively define therebetween a third space 2447 opposite to the second space 2446 and a fourth space 2448 opposite to the first space 2445. The third and fourth spaces 2447, 2448 communicate with the first bore 243 and the first and second spaces 2445, 2446.

The second silicon steel sheets 242 are free from the protrusion section 244. Each second silicon steel sheet 242 has a second bore 245 formed at the center of the second silicon steel sheet 242 in communication with the first bore 243.

According to the above arrangement, the protrusion sections 244 protruding from the inner circumference of the first bore 243 of the first silicon steel sheet 242 are able to effectively press and fix the bearing and provide a dustproof effect. Moreover, with such structure, the manufacturing cost of the fan motor is lowered.

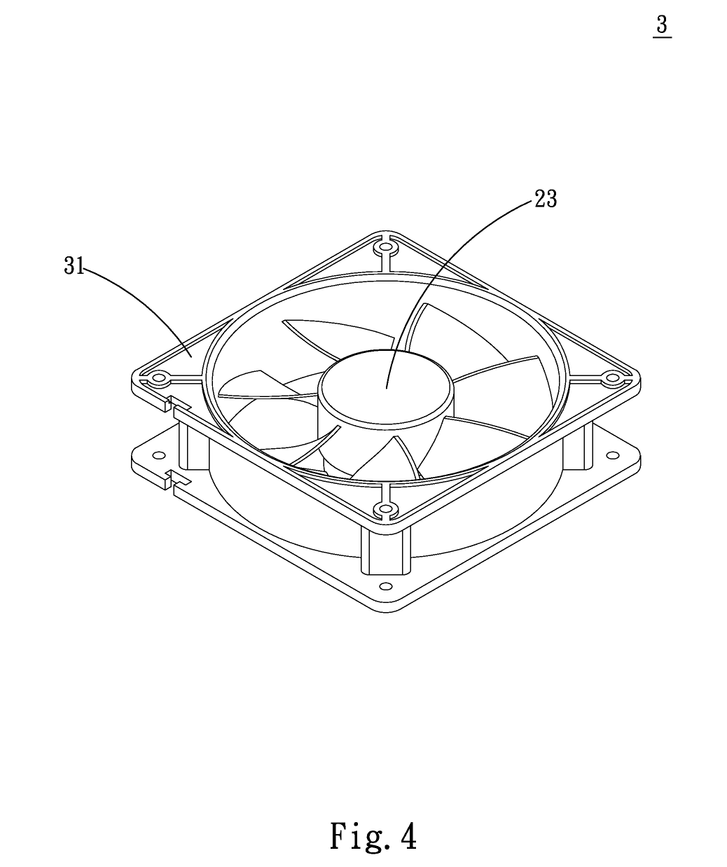

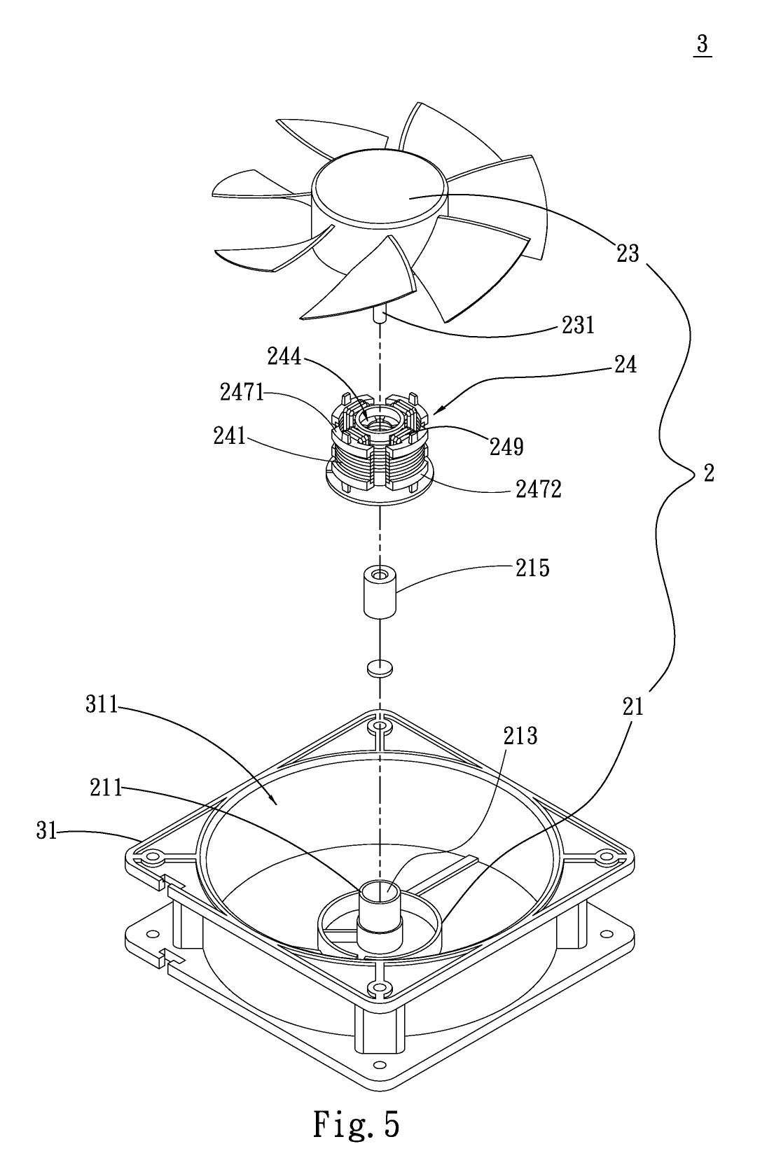

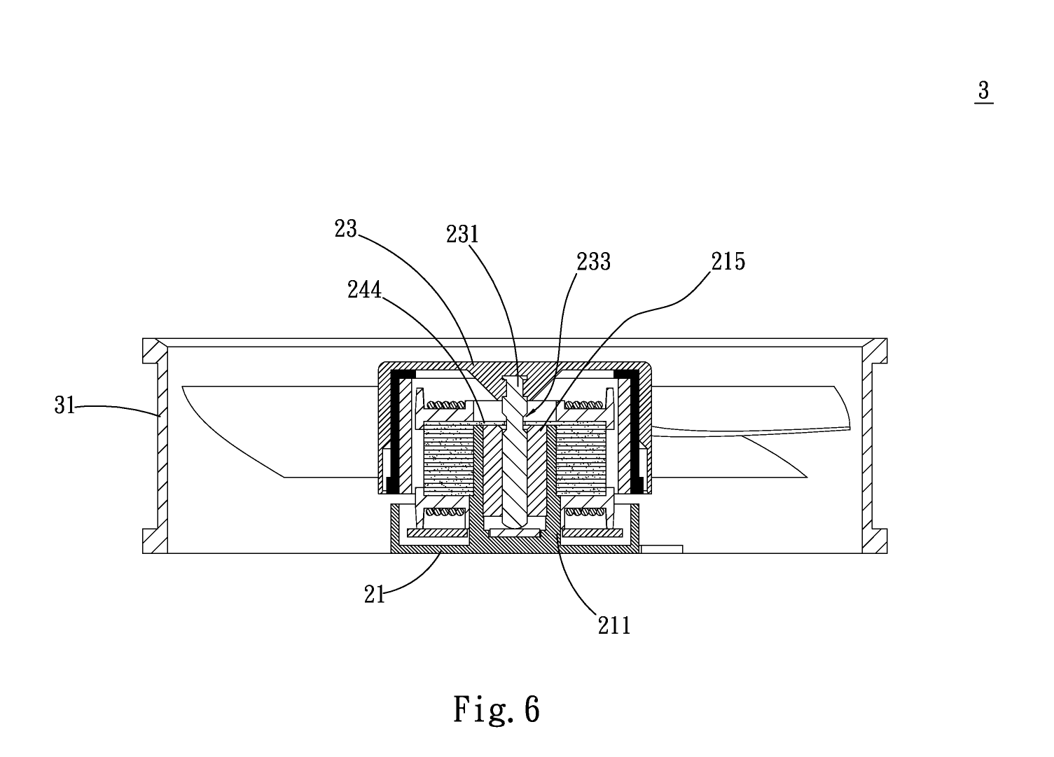

Please now refer to FIGS. 4, 5 and 6. FIG. 4 is a perspective assembled view of a second embodiment of the present invention. FIG. 5 is a perspective exploded view of the second embodiment of the present invention. FIG. 6 is a sectional assembled view of the second embodiment of the present invention. Also referring to FIGS. 2 and 3, in the second embodiment, the fan motor silicon steel sheet structure of the first embodiment is applied to a fan motor 2. The fan motor 2 includes a base seat 21, a rotor 23 and a stator 24. A bearing cup 211 axially extends from the base seat 21. The bearing cup 211 has a bearing hole 213 for receiving a bearing 215.

The stator 24 is fitted around the bearing cup 211. The rotor 23 is capped on the stator 24. The rotor 23 has a shaft 231 fitted through the bearing 215, which is disposed in the bearing hole 213 of the bearing cup 211, whereby the shaft 231 is rotatably positioned in the bearing cup 211. The stator 24 includes a silicon steel sheet assembly 241 and a winding assembly 249 wound on the silicon steel sheet assembly 241. The silicon steel sheet assembly 241 has multiple silicon steel sheets 242, an upper insulation support 2471 and a lower insulation support 2472. The silicon steel sheets 242 are disposed between the upper and lower insulation supports 2471, 2472. The winding assembly 249 has multiple windings wound on the upper and lower insulation supports 2471, 2472 to form the stator 24.

The silicon steel sheets 242 of the second embodiment of the present invention are substantially identical to those of the first embodiment in structure, connection relationship and effect and thus will not be repeatedly described hereinafter. The second embodiment is different from the first embodiment in that the shaft 231 is formed with an annular groove 233. The protrusion section 244 of the first silicon steel sheet 242 extends toward the annular groove 233. One face of the protrusion section 244 abuts against the bearing cup 211 and the bearing 215 to apply a pressing force onto the bearing 215 so as to effectively secure the bearing 215 and provide a dustproof effect. The arched recesses 2441a, 2442a, 2443a, 2444a of the free ends of the first, second, third and fourth protrusion sections 2441, 2442, 2443, 2444 together surround the adjacent annular groove 233, whereby the shaft 231 can stably rotate.

Please further refer to FIGS. 5 and 6. The fan motor 2 of the present invention is applied to a fan 3. The fan 3 includes the stator 24, the rotor 23 and a frame body 31. The frame body 31 has an internal receiving space 311. The base seat 21 is disposed at the center of the receiving space 311. The rotor 23 is rotatably disposed on the bearing cup 211 and received in the receiving space 311. Accordingly, when current passes through the windings of the stator 24 to induce a magnetic field, the rotor 23 is driven to rotate within the receiving space 311.

According to the above arrangement, the protrusion sections 244 of the first silicon steel sheet 242 of the stator 24 directly abut against the bearing 215 disposed in the bearing cup 211 to fix the bearing 215 and provide a dustproof effect. Moreover, with such structure, the manufacturing cost of the fan motor is lowered and the working time is shortened.

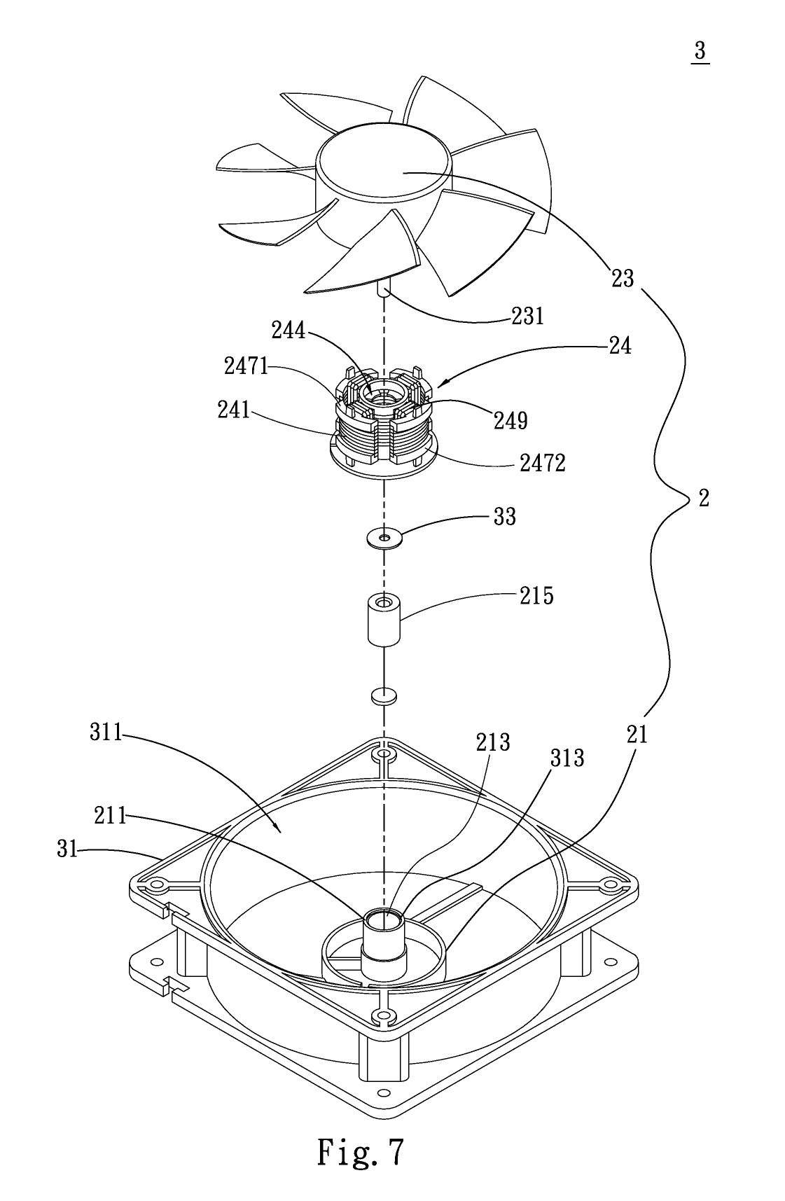

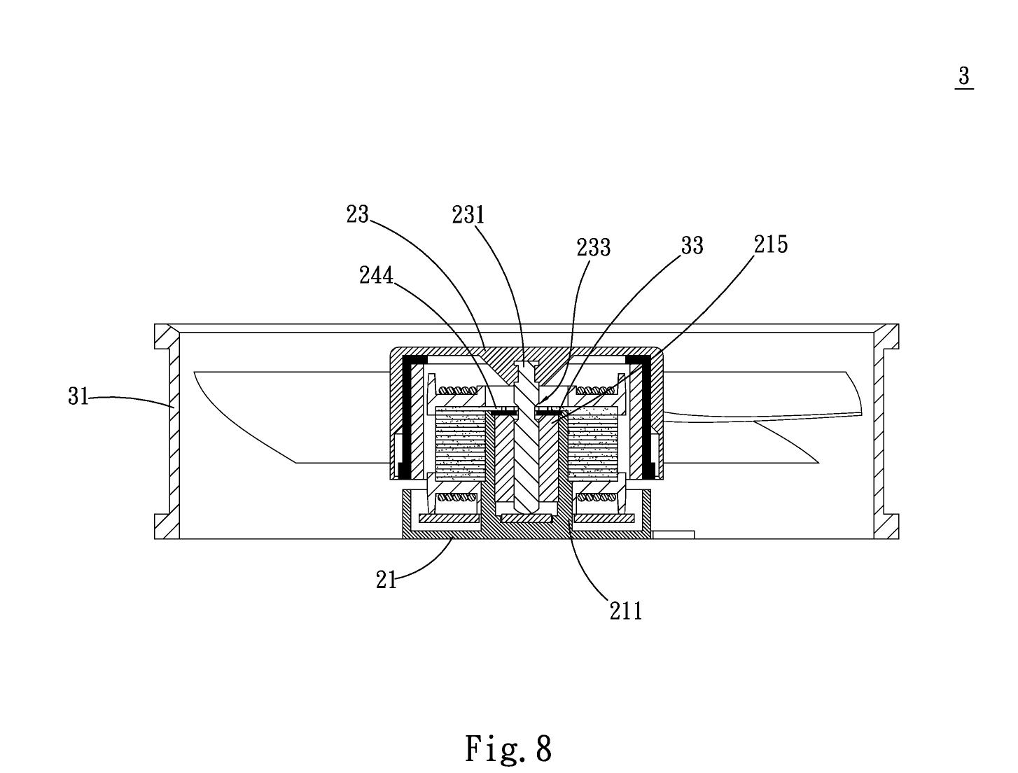

Please now refer to FIGS. 7 and 8. FIG. 7 is a perspective exploded view of a third embodiment of the present invention. FIG. 8 is a sectional assembled view of the third embodiment of the present invention. The third embodiment of the present invention is substantially identical to the second embodiment in structure, connection relationship and effect and thus will not be repeatedly described hereinafter. The third embodiment is different from the second embodiment in that one end of the bearing cup 211, which end is proximal to the protrusion sections 244, is formed with a rest section 313. A retainer ring 33 is disposed in the rest section 313. The retainer ring 33 is fitted around the shaft 231 and inlaid in the annular groove 233 thereof. The retainer ring 33 is positioned between the protrusion section 244 and the bearing 215. The protrusion sections 244 of the first silicon steel sheet 242 abut against one face of the retainer ring 33 to press the other face of the retainer ring 33 against the bearing 215 so as to fix the same and provide a dustproof effect. With such structure, the manufacturing cost of the fan motor is lowered.

In conclusion, in comparison with the conventional technique, the present invention has the following advantages:

1. The protrusion sections 244 of the first silicon steel sheet 242 abut against the bearing 215 so as to fix the bearing 215 and provide a dustproof effect.

2. The manufacturing cost is lowered.

3. The working time is shortened.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A fan motor silicon steel sheet structure comprising a silicon steel sheet assembly, the silicon steel assembly having multiple silicon steel sheets, which overlap one another, the silicon steel sheets including at least one first silicon steel sheet and multiple second silicon steel sheets, the first silicon steel sheet being overlaid on one side of the second silicon steel sheets, the first silicon steel sheet having a first bore and at least one protrusion section, the first bore being formed at a center of the first silicon steel sheet, the protrusion section inward protruding from an inner circumference of the first bore, each of the second silicon steel sheets having a second bore formed at a center of the second silicon steel sheet in communication with the first bore.

2. The fan motor silicon steel sheet structure as claimed in claim 1, wherein each silicon steel sheet has multiple magnetic poles outward extending from an outer circumference of the silicon steel sheet.

3. The fan motor silicon steel sheet structure as claimed in claim 1, wherein the first silicon steel sheet has a first protrusion section, a second protrusion section, a third protrusion section and a fourth protrusion section, the first and third protrusion sections respectively protruding from two opposite sections of the inner circumference of the first bore toward the center thereof, the second and fourth protrusion sections respectively protruding from two other opposite sections of the inner circumference of the first bore toward the center thereof.

4. The fan motor silicon steel sheet structure as claimed in claim 3, wherein two sides of the second protrusion section and the adjacent first and third protrusion sections respectively define therebetween a first space and a second space and two sides of the fourth protrusion section and the adjacent first and third protrusion sections respectively define therebetween a third space and a fourth space, the first, second, third and fourth spaces communicating with the first bore and the second bore.

5. The fan motor silicon steel sheet structure as claimed in claim 3, wherein free ends of the first, second, third and fourth protrusion sections are formed with arched recesses, the free ends of the first, second, third and fourth protrusion sections being radially recessed toward the inner circumference of the first bore to form the arched recesses respectively.

6. A fan motor comprising:
a base seat having a bearing cup axially extending from the base seat, the bearing cup having a bearing hole for receiving a bearing therein;
a rotor having a shaft fitted through the bearing, which is disposed in the bearing hole of the bearing cup, whereby the shaft is rotatably positioned in the bearing cup; and
a stator fitted around the bearing cup, the stator including a silicon steel sheet assembly and a winding assembly wound on the silicon steel sheet assembly, the silicon steel sheet assembly having multiple silicon steel sheets, the multiple silicon steel sheets including at least one first silicon steel sheet and multiple second silicon steel sheets, the first silicon steel sheet being overlaid on one side of the second silicon steel sheets, the first silicon steel sheet having a first bore in communication with the bearing hole and at least one protrusion section, the first bore being formed at a center of the first silicon steel sheet, the protrusion section inward protruding from an inner circumference of the first bore, one face of the protrusion section abutting against the bearing cup and the bearing, each of the second silicon steel sheets having a second bore formed at a center of the second silicon steel sheet in communication with the first bore.

7. The fan motor as claimed in claim 6, wherein each silicon steel sheet has multiple magnetic poles outward extending from an outer circumference of the silicon steel sheet.

8. The fan motor as claimed in claim 6, wherein the first silicon steel sheet has a first protrusion section, a second protrusion section, a third protrusion section and a fourth protrusion section, the first and third protrusion sections respectively protruding from two opposite sections of the inner circumference of the first bore toward the center thereof, the second and fourth protrusion sections respectively protruding from two other opposite sections of the inner circumference of the first bore toward the center thereof.

9. The fan motor as claimed in claim 8, wherein two sides of the second protrusion section and the adjacent first and third protrusion sections respectively define therebetween a first space and a second space and two sides of the fourth protrusion section and the adjacent first and third protrusion sections respectively define therebetween a third space and a fourth space, the first, second, third and fourth spaces communicating with the first bore and the second bore.

10. The fan motor as claimed in claim 8, wherein free ends of the first, second, third and fourth protrusion sections are formed with arched recesses, the free ends of the first, second, third and fourth protrusion sections being radially recessed toward the inner circumference of the first bore to form the arched recesses respectively.

11. The fan motor as claimed in claim 6, which is applied to a fan, the fan including the stator, the rotor and a frame body, the frame body having a receiving space, the base seat being disposed at a center of the receiving space, the rotor being received in the receiving space and capped on the stator.

12. The fan motor as claimed in claim 11, wherein one end of the bearing cup, which end is proximal to the protrusion section, is formed with a rest section, a retainer ring being disposed in the rest section, the retainer ring being fitted around the shaft and inlaid in an annular groove formed on the shaft, the retainer ring being positioned between the protrusion section and the bearing.
